(19) United States
(12) Patent Application Publication
(10) Pub. No.: US 2012/0040319 A1
(43) Pub. Date: Feb. 16, 2012

(54) SYSTEMS AND METHODS FOR MEDICATION COMPLIANCE

(75) Inventors: Cameron Brackett, Pewaukee, WI (US); Michael Harkavy, Hartland, WI (US)

(73) Assignee: Honeywell International Inc., Morristown, NJ (US)

(21) Appl. No.: 12/857,126

(22) Filed: Aug. 16, 2010

(51) Int. Cl. G09B 23/28; G06F 17/00

(52) U.S. Cl. 434/262; 235/375

(57) ABSTRACT

Systems and methods for medication compliance are provided. The method includes registering at least one medication, instructing a user to select the at least one medication, verifying a selected medication, and instructing a user with dosage information associated with the selected medication.

### FIELD OF INVENTION

The present invention relates generally to systems and methods for medication compliance. More particularly, the present invention relates to systems and methods for medication compliance that allow a user to keep medications in their original containers, remind users when to take what medication, and keep track of a user's medication supply and compliance.

### BACKGROUND

The number one reason why a patient is re-admitted to a hospital within thirty days of his or her release is that he or she is not following his or her medication regime properly. There are a number reasons why patients do not follow a prescribed medication regime. For example, some patients choose to ignore a prescribed medication regime.

However, some patients want to follow a prescribed medication regime, but find it hard to do so. For example, some patients are prescribed many medications and find it difficult to keep track of what to take when and with what. Therefore, systems and methods are needed for medication compliance.

Medication compliance systems are known in the art. However, known medication compliance systems have not been able to truly guarantee medication compliance because there are many ways in which a user can bypass or “fool” the system.

Some known medication compliance systems are merely systems that provide reminders to a user to take his or her medications. For example, programs or applications can be downloaded to a smart phone or other personal digital assistant, to remind a user to take his or her medications according to a predetermined schedule. The reminder systems do not truly guarantee compliance.

Furthermore, known medication compliance systems have presented various disadvantages to users of those systems. For example, many known medication compliance systems require a user to transfer his or her medications from their original container to a separate physical box. Often the new container is too big, not big enough, not portable, or expensive. Furthermore, it can be dangerous when transferring medications from a prescription bottle to another container.

Systems and methods for medication compliance are important in the market. However, known systems and methods have been ineffective and/or too expensive, cumbersome, or complex.

There is thus a continuing, ongoing need for improved systems and methods for medication compliance. Preferably, such systems and methods for medication compliance allow a user to keep medications in their original containers, remind users when to take what medication, and keep track of a user's medication supply and compliance.

### BRIEF DESCRIPTION OF THE DRAWINGS

FIG. 1 is a flow diagram of a method of medication compliance in accordance with the present invention;

FIG. 2 is a block diagram of a system for carrying out the method of FIG. 1 in accordance with the present invention;

FIG. 3 is a block diagram of an installed system for medication compliance in accordance with the present invention;

FIG. 4 is a front perspective view of a system for medication compliance in accordance with the present invention;

FIG. 5 is a back perspective view of a system for medication compliance in accordance with the present invention;

FIG. 6 is an interactive window displayed on a viewing screen of a graphical user interface for greeting a user in accordance with the present invention;

FIG. 7 is an interactive window displayed on a viewing screen of a graphical user interface for instructing a user to select a medication in accordance with the present invention;

FIG. 8 is an interactive viewing window displayed on a viewing screen of a graphical user interface for confirming a selected medication bottle and for instructing a user to ingest a predetermined quantity of a medication in accordance with the present invention;

FIG. 9 is a second interactive window displayed on a viewing screen of a graphical user interface for instructing a user to select a medication in accordance with the present invention;

FIG. 10 is an interactive window displayed on a viewing screen of a graphical user interface for rejecting a selected medication and for instructing a user to select a different medication bottle; and

FIG. 11 is an interactive window displayed on a viewing screen of graphical user interface for advising a user of medication compliance in accordance with the present invention.

### DESCRIPTION OF THE PREFERRED EMBODIMENTS

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments of the present invention include systems and methods for medication compliance that allow a user to keep medications in their original containers, remind users when to take what medication, and keep track of a user's medication supply and compliance. Systems and methods in accordance with the present invention can be incorporated into a personal computer, patient hub, smart phone, personal digital assistant or the like.

In embodiments of the present invention, systems and methods can register the type and amount of medications a user is taking. When registering the medication, a user can input the medication's name, routing information, and dosage schedule. The user can also input timing information for when systems in accordance with the present invention should exit a power-saving sleep state and issue a reminder to the user.

In accordance with the present invention, when the system exits a sleep state and wakes up, a user can be told what medication to take, and the system can verity that that user has selected the correct medication bottle. The user can hold a particular medication bottle in front of an associated camera so the camera can read the label of the bottle. For example, the camera can capture a picture of the label and read the label or associated bar code using, for example, OCR. Based on information registered by the user, the selected medication bottle can be either confirmed or rejected.

When a medication bottle is rejected, a user can be instructed to put down the rejected bottle and select the correct bottle. When a medication bottle is confirmed, a user can be instructed about what amount of the medication to take so compliance can be tracked.

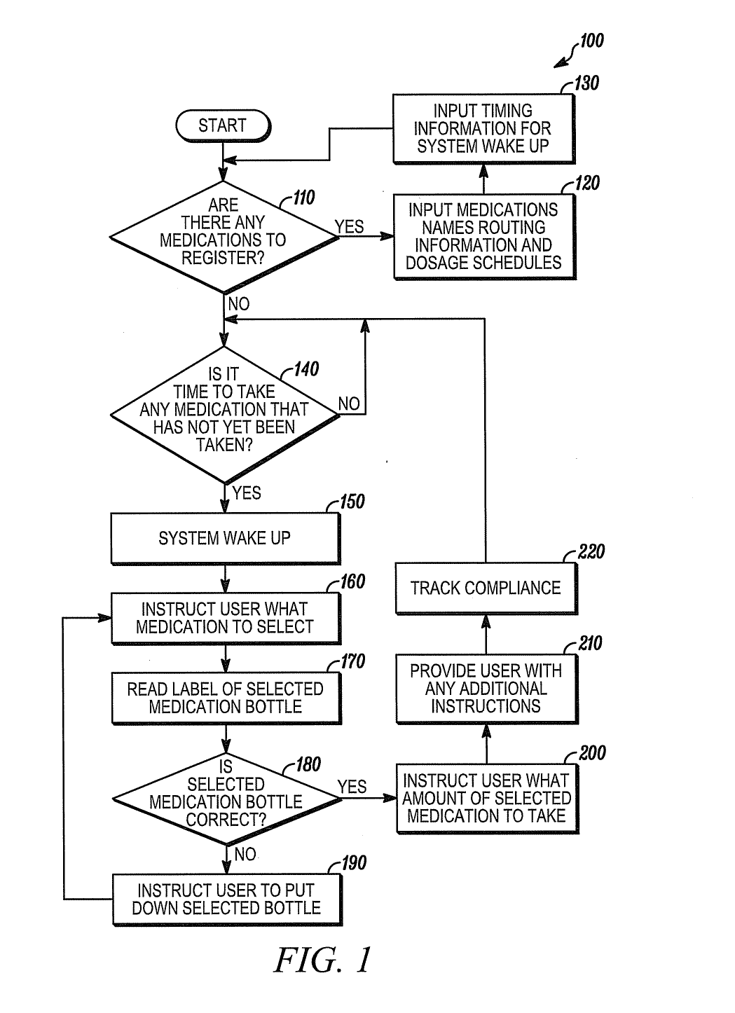

FIG. 1 is a flow diagram of an exemplary method 100 of medication compliance in accordance with the present invention. In the method 100, it can be determined whether there are medications to register as in 110. If there are medications to register, then a registration process can commence for a particular medication.

For example, the medication's name, routing information, and dosage schedule can be input as in 120. Timing information for when the system should exit a sleep state and issue reminders can also be entered as in 130. After the registration process for a particular medication is complete, the method 100 can again determine whether there are medications to register as in 110.

When it is determined that there aren't any (or any more) medications to register as in 110, then it can be determined whether it is time to take any medication that has not yet been taken as in 140. If it is determined that there are no medications to take, then the system continues monitoring whether there are medications to take as in 140.

However, when it is determined that there are medications to take that have not yet been taken, the system can exit a power-saving sleep state and wake up as in 150. Timing information entered as in 130 can be used to determine when the system wakes up as in 150.

A user can be instructed what medication to select as in 160. To verify that the correct medication has been selected, a user can hold a medication bottle in front of an associate camera, and the label of the medication bottle can be read as in 170. Reading the bottle can include scanning an associated barcode and/or taking a picture of the bottle and using OCR to identify the bottle.

Once the bottle is read, it can be determined whether the medication bottle is the correct bottle for the instructions issued as in 160. If the medication bottle is incorrect, then the user can be instructed to put down the rejected bottle as in 190 and select the correct bottle as in 160.

If the selected medication bottle is correct, then the user can be instructed what amount of the medication to take as in 200. The user can also be provided with any additional or special instructions associated with the selected medication as in 210. For example, the user can be instructed to take the medication with water or food, or to eat food within a certain period of time.

Compliance can be tracked as in 220, and then the system can continue monitoring whether there are more medications to take as in 140.

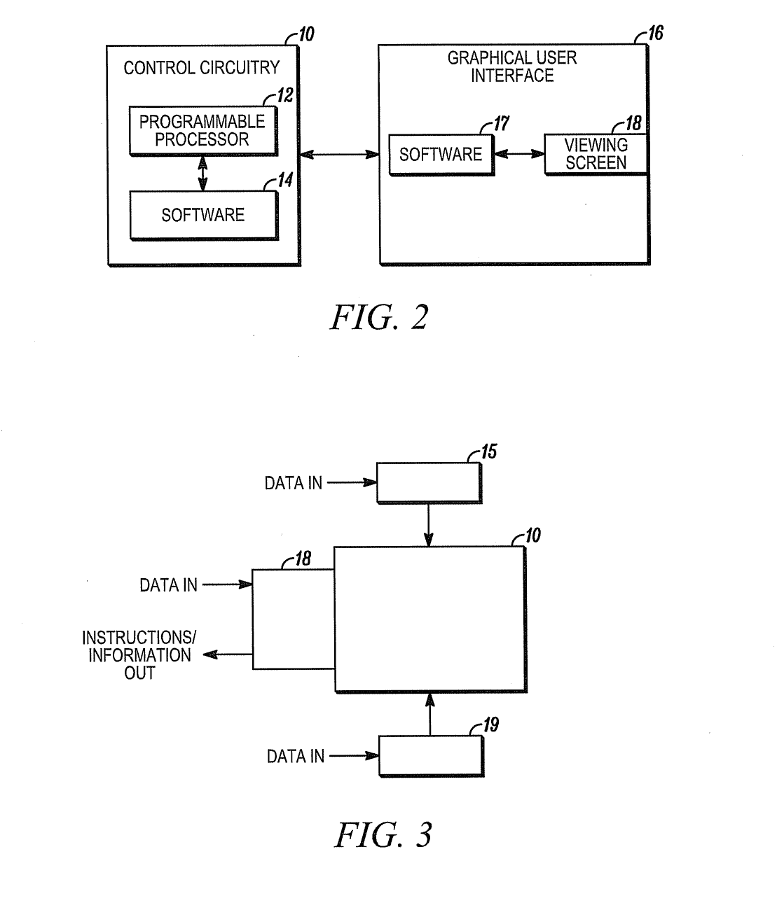

The method shown in FIG. 1 and others in accordance with the present invention can be implemented with a programmable processor and associated control circuitry. As seen in FIG. 2, control circuitry 10 can include a programmable processor 12 and software 14, stored on a local computer readable medium, as would be understood by those of ordinary skill in the art.

An associated user interface 16 can be in communication with the processor 12 and associated circuitry 10. A viewing screen 18 of the user interface 16, as would be known by those of skill in the art, can display interactive and viewing windows. In embodiments of the present invention, the user interface can be a multi-dimensional graphical user interface.

FIG. 3 is a block diagram of an installed system for medication compliance in accordance with the present invention. As seen in FIG. 3, the control circuitry 10 can be associated with a viewing screen 18, a data collection device 15, for example, a camera, and a data input device 19, for example, a keyboard. A user may input information to the control circuitry 10 and associated programmable processor 12 of the system during a medication registration process and/or while selecting and taking medication by any or all of the viewing screen 18, the camera 15, or the keyboard 19.

The camera 15 can receive input by capturing pictures of an object within the viewing range of the camera 15. For example, as explained above, the camera 15 can capture a picture of a medication bottle held in front of the camera. The camera can also capture a picture of a user making a gesture or symbol, or performing an action.

The data input device 19 can receive input by obtaining information from a user as would be known by those of skill in the art for the particular data input device employed. For example, if the data input device 19 includes a keyboard, a user can enter keystrokes.

The viewing screen 18 can receive input via a graphical user interface. In embodiments of the present invention, the viewing screen 18 can be interactive. For example, the viewing screen 18 can be associated with touch screen technology as known in the art, and a user can select or deselect various icons or other representations for inputting information.

The viewing screen 18 can also provide information to the user. For example, the viewing screen 18 can display instructions to the user for what medication to take and the dosage amount for that medication. In some embodiments, instructions displayed to the user via the viewing screen 18 can also be orally conveyed to the user via an associated speaker or audio terminal.

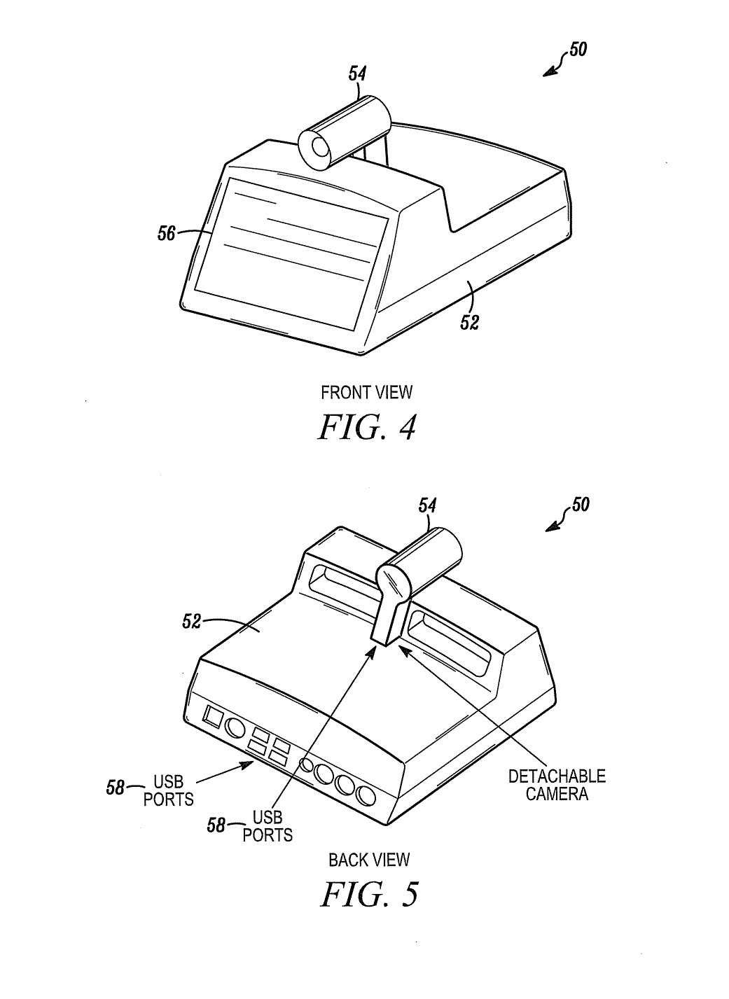

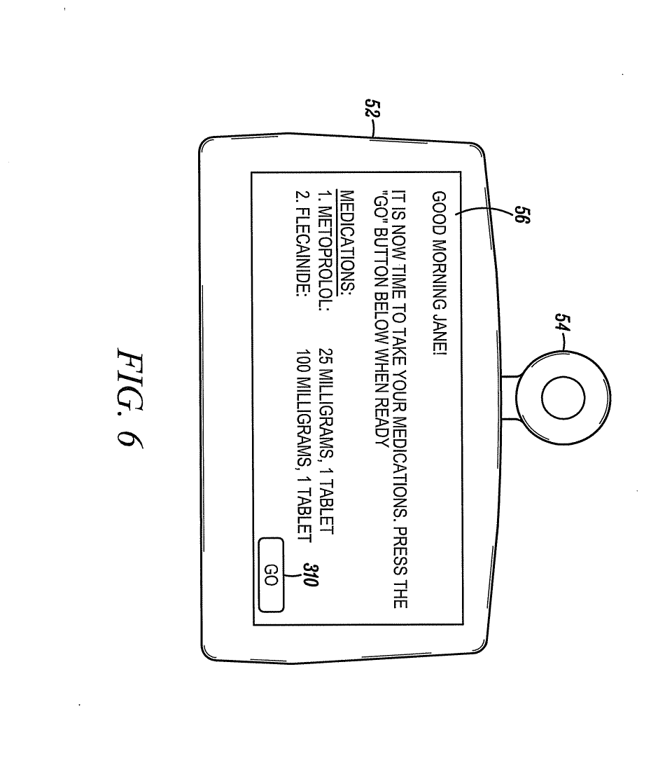

FIG. 4 is a front perspective view of a system for medication compliance in accordance with the present invention, and FIG. 5 is a back perspective view of a system for medication compliance in accordance with the present invention. As seen in FIGS. 4 and 5, a system 50 in accordance with the present invention can include a terminal housing 52, a camera 54, and a viewing screen 56. In some embodiments of the present invention, the camera 54 can be detachable from the terminal housing 52. In some embodiments, the terminal housing 52 can also include USB ports 58 for connecting to the Internet or other devices as would be known by those of skill in the art.

The interactive and viewing windows shown and described herein are exemplary only. Those of skill in the art will understand that the features of the windows shown and described herein may be displayed by additional or alternate windows.

FIG. 6 is an interactive window displayed on a viewing screen 56 of a graphical user interface for greeting a user in accordance with the present invention. When a system in accordance with the present invention exits a sleep state, the viewing screen 56 can display a welcome or greeting message to the user. For example, the message can advise the user that it is time to take his or her medications and can instruct the user about what medications will be taken during the present session.

As seen in FIG. 6, the viewing screen 56 can employ touch screen technology known in the art and display a GO icon or “button” 60. When the user is ready to proceed, he or she can select the icon 60 by touching the screen 56 on or near the location where the icon 60 is displayed.

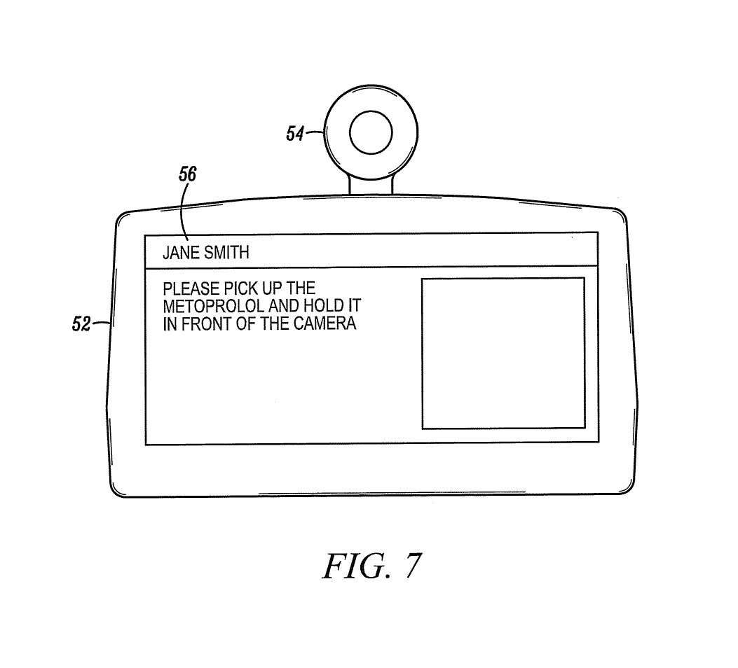

FIG. 7 is an interactive window displayed on a viewing screen 56 of a graphical user interface for instructing a user to select a medication in accordance with the present invention. As seen in FIG. 7, the viewing screen 56 can display instructions to a user for selecting a particular medication bottle.

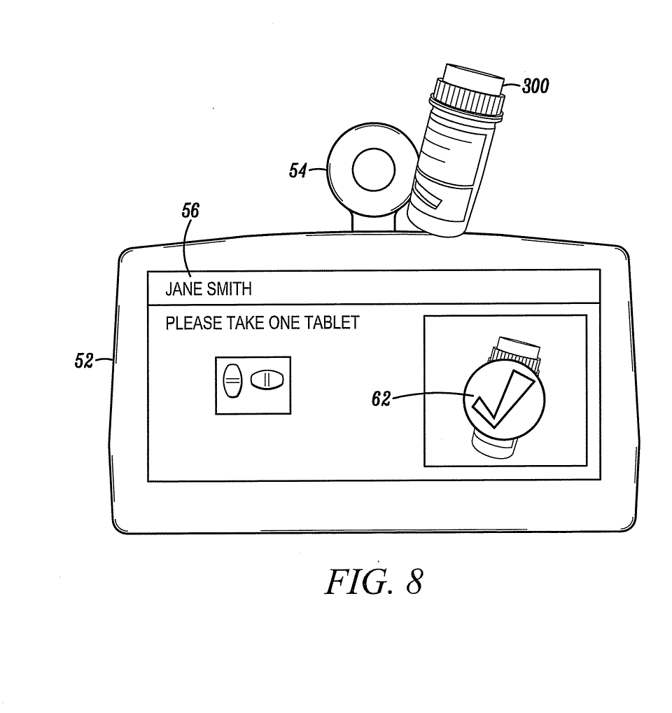

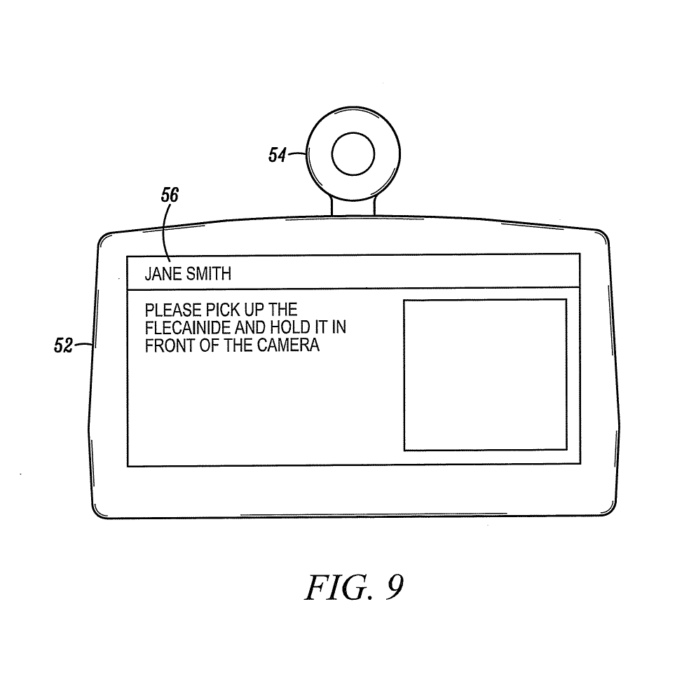

FIG. 8 is an interactive viewing window displayed on a viewing screen 56 of a graphical user interface for confirming a selected medication bottle and for instructing a user to ingest a predetermined quantity of a medication in accordance with the present invention. As seen in FIG. 8, a selected medication bottle 300 can be held in front of the camera 54 or other data collection device for capturing a picture of the bottle and/or reading the bottle or an associated barcode. If the bottle 300 is confirmed as being the correct medication bottle, then the viewing screen 56 can display a confirmation symbol 62 that the correct bottle was chosen.

Once it is confirmed that the correct medication bottle is chosen, the viewing screen 56 can display instructions to a user for ingesting a predetermined quantity of the medication. Information entered during the registration of the medication can be used to determine the dosage amount for the selected medication.

FIG. 9 is a second interactive window displayed on a viewing screen 56 of a graphical user interface for instructing a user to select a medication in accordance with the present invention. The viewing screen 56 can display instructions to a user for selecting a particular medication bottle.

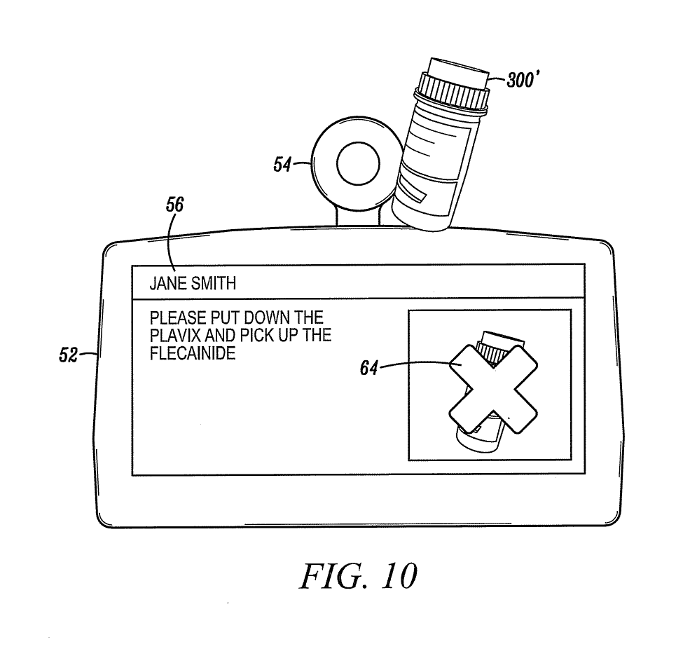

FIG. 10 is an interactive window displayed on a viewing screen of a graphical user interface for rejecting a selected medication and for instructing a user to select a different medication bottle. As seen in FIG. 10, a selected medication bottle 300′ can be held in front of the camera 54 or other data collection device for capturing a picture of the bottle 300′ and/or reading the bottle 300′ or an associated barcode.

If the bottle is not the correct bottle in accordance with previous instructions provided to the user, then the viewing screen can display a rejection symbol 64 that the incorrect bottle was selected. If the incorrect bottle was selected, the viewing screen 56 can display instructions to put down the previously selected bottle and select the correct bottle.

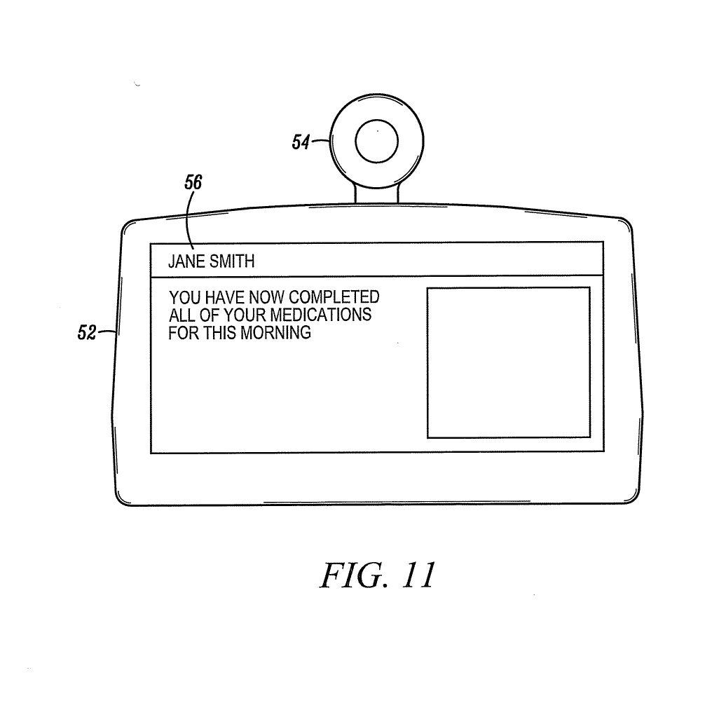

FIG. 11 is an interactive window displayed on a viewing screen 56 of graphical user interface for advising a user of medication compliance in accordance with the present invention. As seen in FIG. 11, when all medications have been completely and correctly taken, a user can be advised that his or her medication session is complete.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the sprit and scope of the claims.

What is claimed is:

1. A method comprising:
registering at least one medication;
instructing a user to select the at least one medication;
verifying a selected medication; and
instructing a user with dosage information associated with the selected medication.

2. The method of claim 1 wherein registering the at least one medication includes receiving at least one of a name of the medication and a dosage schedule for the medication.

3. The method of claim 2 wherein registering the at least one medication further includes receiving timing information for when to instruct the user to select the at least one medication.

4. The method of claim 3 wherein the timing information includes information for a compliance system exiting a power-saving sleep state.

5. The method of claim 1 wherein registering the at least one medication includes receiving information associated with the medication via at least one of a camera, an interactive screen, and a keyboard.

6. The method of claim 1 wherein verifying the selected medication includes receiving information about the selected medication.

7. The method of claim 6 wherein inputting information about the selected medication includes capturing an image of the selected medication.

8. The method of claim 7 further comprising analyzing the captured image using OCR.

9. The method of claim 6 wherein receiving information about the selected medication includes scanning a barcode associated with the medication.

10. The method of claim 1 wherein at least one of instructing the user to select the at least one medication and instructing the user with dosage information further comprises providing instructions via an interactive screen.

11. The method of claim 1 further comprising providing compliance instructions associated with the selected medication.

12. A system comprising:
a housing;
a programmable processor and associated control circuitry;
a data collection device; and
a viewing screen, wherein medication and dosage instructions are provided to a user using the viewing screen, and medication compliance is verified using the data collection device.

13. The system of claim 12 wherein the data collection device includes at least one of a camera and a keyboard.

14. The system of claim 13 wherein user input is received via at least one of the camera, the keyboard, and the viewing screen.

15. The system of claim 12 wherein the programmable processor and associated control circuitry enter a power-saving sleep state when medication and dosage instructions are not being provided to the user and when medication compliance is not being verified.

16. A system comprising:
circuitry to register at least one medication;
circuitry to instruct a user to select the at least one medication;
circuitry to verify a selected medication; and
circuitry to instruct a user with dosage information associated with the selected medication.

17. The system of claim 16 wherein the circuitry to verify the selected medication includes circuitry to receive information about the selected medication.

18. The system of claim 16 wherein the circuitry to receive information about the selected medication includes circuitry to capture a picture of the selected medication.

19. The system of claim 16 wherein at least one of the circuitry to instruct the user to select the at least one medication and the circuitry to instruct the user with dosage information further comprises circuitry to provide instructions via an interactive screen.

20. The system of claim 16 further comprising circuitry to provide compliance instructions associated with the selected medication.
